(19) United States
(12) Patent Application Publication
(10) Pub. No.: US 2014/0001124 A1
(43) Pub. Date: Jan. 2, 2014

(54) SYSTEM FOR OXIDATION OF ARSENIC (III) IN GROUNDWATERS WITH HIGH IRON AND MANGANESE CONCENTRATIONS AND METHOD THEREFOR

(71) Applicants: Thomas John Sorg, Cincinnati, OH (US); Abraham Shou-Chien Chen, North Bethesda, MD (US)

(72) Inventors: Thomas John Sorg, Cincinnati, OH (US); Abraham Shou-Chien Chen, North Bethesda, MD (US)

(21) Appl. No.: 13/534,465

(22) Filed: Jun. 27, 2012

(51) Int. Cl. C02F 1/58; B01J 8/04; C02F 1/28; C02F 1/72

(52) U.S. Cl. 210/662; 210/290; 210/275; 210/668

(57) ABSTRACT

A single, mixed-bed column of Birm® over Filox® to remove iron and manganese, thereby protecting Filox®, the oxidizing media, from fouling by iron and manganese. This helps to remove iron and manganese to low levels so that As(III) may be oxidized to As(V) more efficiently before it is treated with adsorptive media.

### FIELD OF THE INVENTION

This invention relates generally to the treatment of potable water and more specifically, to a system and method for oxidizing arsenic(III) in groundwaters or other source water having high iron and manganese concentrations.

### BACKGROUND OF THE INVENTION

Arsenic is a common, naturally occurring contaminant in groundwater. When arsenic (III) is the predominant arsenic form in source water, oxidation of arsenic (III) to arsenic (V) is required for more effective removal. The presence of iron and manganese in source water has also proven to be problematic.

As required by the Safe Drinking Water Act of 1973, the U.S. Environmental Protection Agency (EPA) established a Maximum Contaminant Level (MCL) for arsenic in drinking water at 0.05 mg/L in 1975. On Jan. 18, 2001, the EPA revised the arsenic MCL from 0.05 mg/L to 0.01 mg/L and then on Mar. 23, 2003 the EPA clarified the MCL rule to be 0.010 mg/L (or 10 μg/L). The final revised rule required all community and non-transient, non-community water systems to comply with the new MCL by Jan. 23, 2006. With the lower arsenic MCL, the EPA estimated that approximately 5,000 water systems would be out of compliance and that the vast majority of these water systems would need to install some type of arsenic removal system. Furthermore, most of these water systems were small systems serving less 10,000 consumers with many providing water to less than 1,000 people. With limited resources, these small/very small systems have a critical need for low cost arsenic treatment systems, especially when iron and manganese are also present in source water.

### SUMMARY OF THE INVENTION

In accordance with one embodiment of the present invention, a mixed-bed oxidizing media vessel for oxidizing arsenic(III) in source water having concentrations of iron and/or manganese is disclosed. The mixed-bed media vessel comprises: a housing; a first oxidizing media for oxidizing the dissolved iron and/or the manganese present in the source water; and a second oxidizing media for oxidizing arsenic(III) to arsenic(V) present in the source water, wherein the second oxidizing media is positioned below the first oxidizing media within the housing.

In accordance with another embodiment of the present invention, a system for oxidizing arsenic(III) in source water having concentrations iron and/or manganese is disclosed. The system comprises: at least one mixed-bed media vessel for oxidizing dissolved iron and/or manganese and for oxidizing arsenic(III) to arsenic(V); and a backwash system coupled to the at least one mixed-bed media vessel.

In accordance with another embodiment of the present invention, a method for treating source water having concentrations of arsenic and at least one of iron and manganese is disclosed. The method comprises the steps of: providing a pre-oxidation system, wherein the pre-oxidation system comprises: at least one mixed-bed media vessel comprising: a housing; a manganese dioxide-coated media; and a manganese dioxide-based media, wherein the manganese dioxide-based media is positioned below the manganese dioxide-coated media within the housing; providing an adsorption vessel containing arsenic adsorption media coupled to the at least one mixed-bed media vessel; providing a backwash system coupled to the at least one mixed-bed media vessel and to the adsorption vessel; running the source water through the at least one mixed-bed media vessel; oxidizing ferrous iron present in the source water to ferric iron with the manganese dioxide-coated media; oxidizing reduced Mn²⁺ present in the source water to Mn⁴⁺ with the manganese dioxide-coated media; oxidizing arsenic(III) present in the source water to arsenic(V) with the manganese dioxide-based media; adsorbing arsenic(V) present in effluent from the at least one mixed-bed media vessel with the arsenic adsorption media in the adsorption vessel; and backwashing at least one of the mixed-bed media vessel and the adsorption vessel.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

The present invention will become more fully understood from the detailed description and the accompanying drawings, wherein:

FIG. 1 is line graph showing a comparison of arsenic concentration in a source of raw water versus the arsenic concentration in the same source water that is pre-treated with chlorine in order to oxidize As(III) to Arsenic(V) prior to entering a full-scale iron-based adsorptive media treatment system.

FIG. 2a is a schematic of a test system used to evaluate and compare the oxidizing capability of three oxidizing media products: Filox®, Pyrolox®, and Birm®.

FIG. 2b is a schematic of the test system FIG. 2a modified to include a fourth column of oxidizing media containing fresh Filox® that receives effluent from the Birm® column.

FIG. 3 is a line graph showing arsenic speciation test results on another source of raw water used during a pilot study.

FIG. 4 is a line graph showing arsenic concentrations of the water of the pilot study after flowing through the Filox® oxidation column of the test system of FIG. 2a.

FIG. 5 is a line graph showing arsenic concentrations of the water of the pilot study after flowing through the Birm® oxidation column of the test system of FIG. 2a.

FIG. 6 is a line graph showing arsenic concentrations of the water of the pilot study after flowing through a Birm® oxidation column and a Filox® oxidation column of the modified test system of FIG. 2b.

FIG. 7 is a schematic of an embodiment of a single oxidation column of Birm® on top of Filox®.

FIG. 8 is a cross-section of an embodiment of an arsenic treatment system comprising a Birm®/Filox® As(III) pre-oxidation vessel and a cross-section of an Adsorbsia® GTO® adsorption vessel.

FIG. 9a is a schematic of another embodiment of an arsenic treatment system having two parallel pre-oxidation/filtration vessels and an adsorption vessel.

FIG. 9b is a schematic of the arsenic treatment system of FIG. 9a wherein the pre-oxidation/filtration vessels are Birm®/Filox® vessels and the adsorption vessel is an Adsorbsia® GTO® vessel.

FIG. 10 is a bar graph showing arsenic speciation test results on another sample of raw water used during a performance evaluation study.

FIG. 11 is bar graph showing arsenic speciation of effluent from a Birm®/Filox® pre-oxidation system.

FIG. 12 is a bar graph showing iron speciation test results the raw water used during the performance evaluation study.

FIG. 13 is a bar graph showing iron speciation of effluent from a Birm®/Filox® pre-oxidation system.

FIG. 14a is a line graph showing a comparison of manganese concentration in the raw water used during the performance evaluation study versus the manganese concentration in the same source water after having been treated by a Birm®/Filox® oxidation system.

FIG. 14b is a line graph showing a comparison of manganese concentration in the raw water used during the performance evaluation study versus the manganese concentration in the same source water after having been pre-oxidized by a Birm®/Filox® oxidation system and by an Adsorbsia® GTO® system.

FIG. 15 a schematic of another embodiment of an arsenic treatment system showing Birm®/Filox® vessels, an Adsorbsia® GTO® adsorption vessel, a backwashing system, and several sampling locations.

### DETAILED DESCRIPTION OF THE PREFERRED EMBODIMENTS

Although it can exist in both organic and inorganic forms, only the inorganic arsenic is significant in potable water supplies. Inorganic arsenic has two oxidation states: arsenic (+III) (arsenite) and arsenic (+V) (arsenate). Both As(III) and As(V) exist in the pH range of 6 to 9. The primary arsenate species are monovalent H₂AsO₄⁻ and divalent HAsO₄²⁻. These anions result from the dissociation of arsenic acid (H₃AsO₄), which exhibits pKa values of 2.2, 7.0, and 11.5. The predominant As(III) species is uncharged arsenious acid (H₃AsO₃). Only at pH values above its pKa of 9.2 does the monovalent arsenite anion (H₂AsO₃⁻) predominate.

As(V) is effectively removed by most arsenic treatment processes whereas uncharged As(III) is poorly removed. For example, anion exchange (AIX) resins can remove nearly 100% of As(V), but no As(III). (See Ficklin, W. H.1983. Separation of Arsenic (III) and Arsenic (V) in Groundwaters by Ion Exchange. Talanta, 30(5):371; see also Clifford, D. A., Sorg, T. T. and Ghurye, G. L. 2011. Ion Exchange and Adsorption of Inorganic Contaminants. Chapter 12, Water Quality and Treatment, Sixth Edition, McGraw Hill). The AIX process, therefore, requires As(III) to be oxidized to As(V) to achieve satisfactory removal.

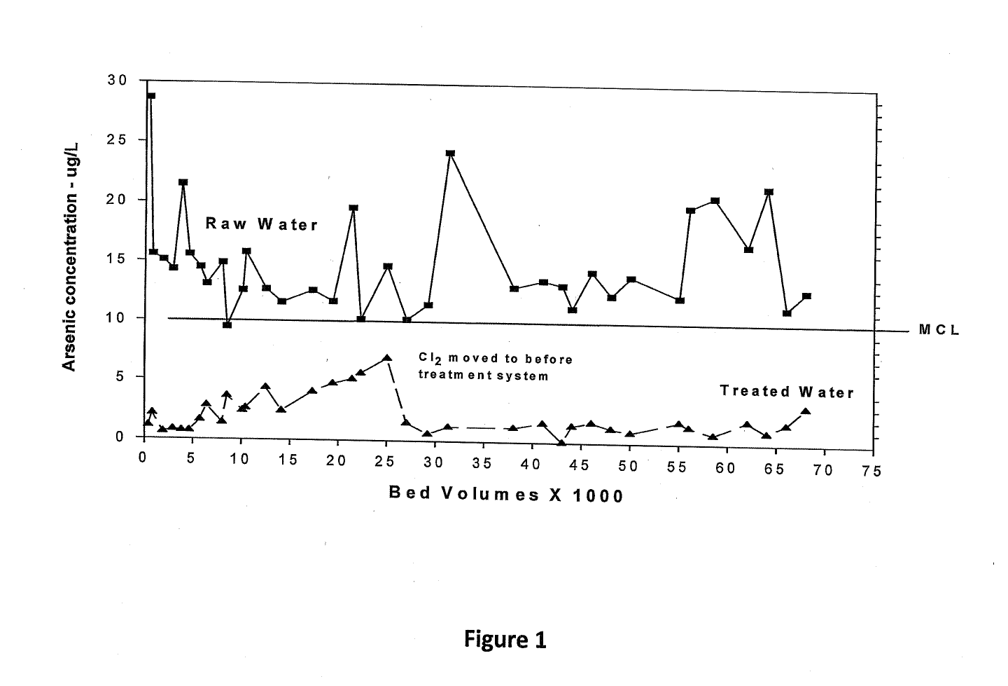

Referring to FIG. 1, the importance of converting (oxidizing) As(III) to As(V) was demonstrated where a 640 gallons per minute (gpm) full-scale iron-based adsorptive media system was used to treat raw water containing around 20 μg/L As(III). (See Chen, A. S. C., Condit, W. E., Wang, L., and Wang, A. 2008a. Arsenic Removal from Drinking Water by Adsorptive Media, U.S. EPA Demonstration Project at Queen Anne's County, Md., Final Performance Evaluation Report. EPA/600/R-08/141. U.S. Environmental Protection Agency, National Risk Management Research Laboratory, Cincinnati, Ohio). After treating approximately 8,000 bed volumes (BV) of water in 133 days, arsenic in the treated water exceeded the MCL of 10 μg/L. To increase the media's arsenic removal capacity, chlorine (Cl₂) was added to the source water upstream of the treatment system in order to oxidize As(III) to As(V). By making this change, arsenic in the treated water immediately decreased to less than 2 μg/L. The system continued to operate for more than five years treating over 60,000 BV of water with arsenic levels in the treated water still below the arsenic MCL in the 5 to 6 μg/L range. A similar result occurred with a full-scale arsenic treatment system. (See Chen, A. S. C., Lewis, G. M., Wang, L., and Wang, A. 2008b. Arsenic Removal from Drinking Water by Adsorptive Media, U.S. EPA Demonstration Project at Brown City, Mich., Final Performance Evaluation Report. EPA/600/R-08/142. U.S. Environmental Protection Agency, National Risk Management Research Laboratory, Cincinnati, Ohio). Consequently, when As(III) is the predominant species in source waters, pre-oxidation of As(III) to As(V) is always recommend for more effective arsenic removal.

In one study, seven different oxidants—chlorine, permanganate, ozone, monochloramine, chlorine dioxide, Filox® (a manganese dioxide [MnO₂] solid oxidizing media manufactured by Watts Water Quality and Conditioning Products, Inc.), and ultraviolet light (UV) at 254-nm—were tested for their ability to convert As(III) to As(V). (See Ghurye, G. L. and Clifford, D. A. 2001. Laboratory Study on the Oxidation of Arsenic III to Arsenic V. EPA/600/R-01/021. U.S. Environmental Protection Agency, National Risk Management Research Laboratory, Cincinnati, Ohio). The study evaluated the effects of pH (6.3 to 8.3), temperature (5 to 25° C.), and interfering reductants such as Mn²⁺, Fe²⁺, S²⁻, and total organic carbon (TOC). Of the seven oxidants, only chlorine and permanganate were shown to provide complete oxidation in less than 1 min under all conditions. Ozone was fast and effective, but significantly impacted by TOC.

One of the seven tested oxidants was Filox®, which is a brand name for pyrolusite, a naturally-occurring MnO₂ product supplied in granular forms. Filox® is slightly different from other pyrolusite products such as, Pyrolox®, because of its very high MnO₂ content (75 to 85%). One of the conclusions drawn from the tests conducted with Filox® was that the media was very effective for As(III) oxidation under most conditions tested. More than 95% of As(III) was oxidized with both low and high dissolved oxygen (DO) levels and at contact times as short as 1.5 min when the test water contained no interfering reductants such as dissolved iron, manganese, sulfide, and total organic carbon (TOC). All interfering reductants studied showed some detrimental effects particularly with test waters containing low DO and with a low empty bed contact time (EBCT) of 1.5 minutes. With high DO and an EBCT of 6 minutes, the effects of the interfering reductants were attenuated.

In another study of four solid oxidizing media (Filox®, Pyrolox®, Birm®, and manganese greensand) using a NSF International (NSF) challenge water, preliminary screening tests on Filox®, Pyrolox®, and Birm® showed only Filox® and Pyrolox® to be very effective for As(III) oxidation (>95%). (See Lowry, J., Clifford, D., Ghurye, G, Karori, S., Narasimhan, R. and Thomson, B. 2005. Arsenic Oxidation by Solid-Phase Media or a UV-Sulfite Process. Awwa Research Foundation, Denver, Colo.). The least effective media was Birm®, achieving only <60% oxidation under optimum conditions of high DO and 1 to 3 minutes EBCT. Based upon these short-term screening tests, Birm® was dropped from further testing and replaced by manganese greensand.

In continuing tests with DO at low levels, only Filox® and Pyrolox® were found to effectively oxidize As(III) whereas manganese greensand only achieved 33% As(III) oxidation. Further testing found that ferrous iron at 2.0 mg/L had a negative impact on As(III) oxidation of both Filox® and Pyrolox® within a short period of time and As(III) oxidation continued to decrease with time. The decrease in oxidation effectiveness was attributed to the oxidation of ferrous iron that competes with As(III) and to the precipitated ferric hydroxide that coats the media and reduces accessibility of As(III) for oxidation sites. Because Filox® is less fragile than Pyrolox®, Filox® may be the preferred media when a solid oxidizing media is used.

### Example 1

### Pilot Study

A pilot study was conducted to evaluate the effectiveness of six different commercially available adsorptive media for As(III) and As(V) removal. (See Chen, A. S. C. 2011. Pilot-Scale Evaluations of Arsenic Removal Adsorptive Media at Licking Valley High School in Newark, Ohio. Letter Report (Unpublished), Contract No. EP-C-05-057, Task Order No. 0019. U.S. Environmental Protection Agency, National Risk Management Research Laboratory, Cincinnati, Ohio). The pilot study was conducted with a water supply extracted from a well. The groundwater contained high levels of total arsenic (around 74 μg/L), total iron (around 2.2 mg/L), and total manganese (around 0.165 mg/L). Speciation tests indicated that arsenic existed mainly as As(III).

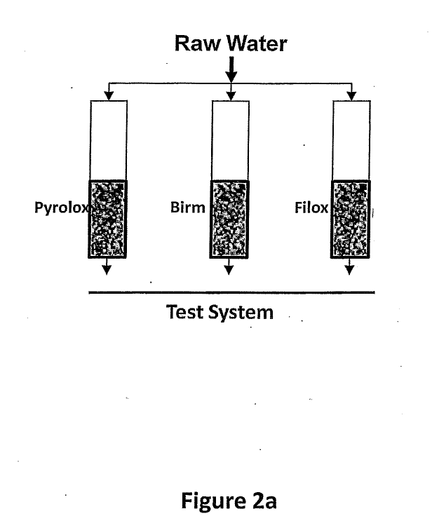

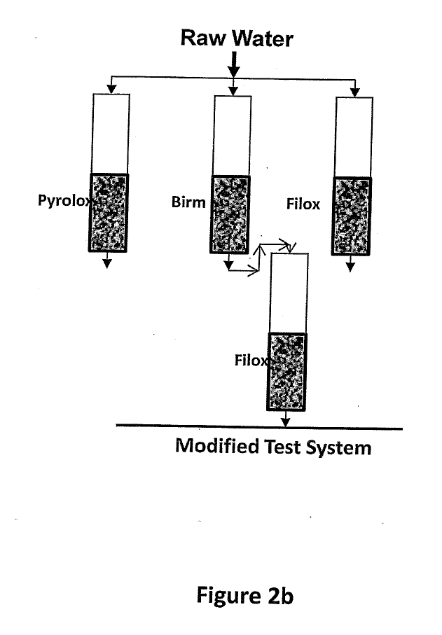

In order to conduct the media tests for As(V) removal, oxidation of As(III) was required. To select a pre-oxidation system, a pilot study was conducted to evaluate and compare the oxidizing capability of three oxidizing media products: Filox®, Pyrolox®, and Birm®. The test system used during the pilot study consisted of three 2-in×4 ft glass columns, each containing 12.5 in of a media. A schematic of the test system is shown in FIG. 2a. Although glass columns were used, it should be clearly understood that any suitable housing or vessel may be used.

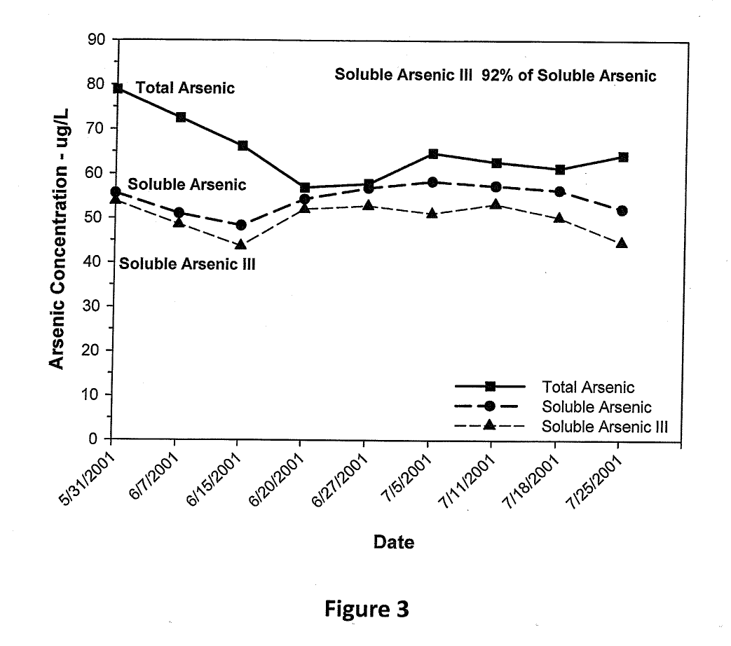

During the 48-day (1,172 hr) pilot study, the groundwater had an average total arsenic concentration of 74 μg/L, an average total iron concentration of 2.2 mg/L, and an average total manganese concentration of 0.165 mg/L (12 water samples). Of the soluble arsenic fraction, speciation tests indicated that 90 to 96% was As(III). FIG. 3 shows arsenic speciation test results on the raw water used during the pilot study.

The tests began using an EBCT of 2.1 minutes and no backwashing of the media. After one week of operation, none of the three media were found to be effective for As(III) oxidation (12 to 22%), which was attributed to the lack of backwashing of the media. The media were backwashed and after another week of operation, very poor oxidation of As(III) was observed again. After backwashing and increasing the EBCT to 5 minutes with no improvement in As(III) oxidation, it was concluded that the media were fouled (coated) with iron because of the lack of backwashing. All of these media have been used successfully for iron and manganese removal and were found to remove iron during the tests. Because precipitated iron will adsorb some As(III) and As(V), all three media tested reduced total arsenic concentrations by 37 to 43%.

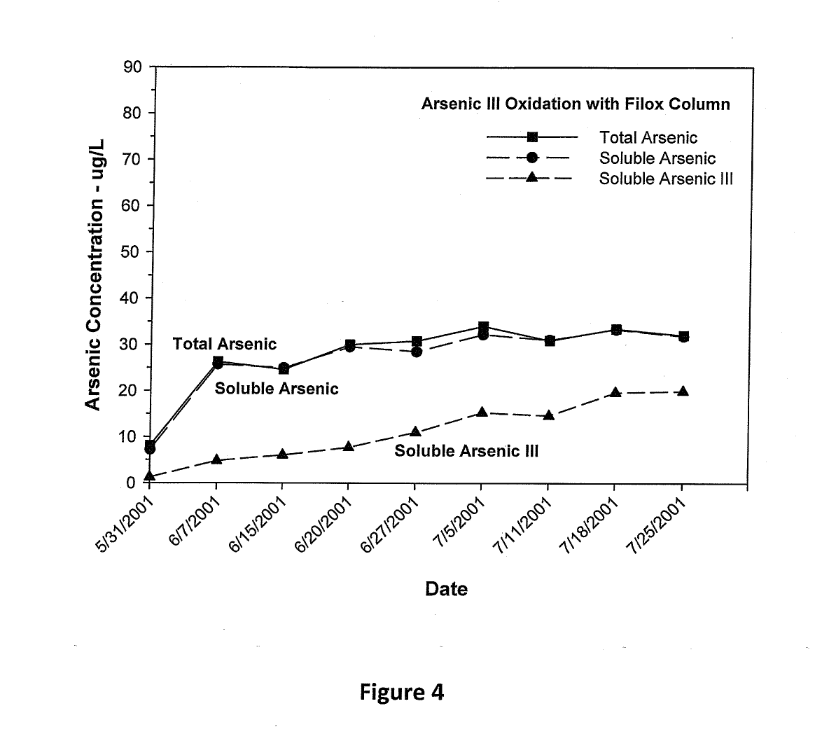

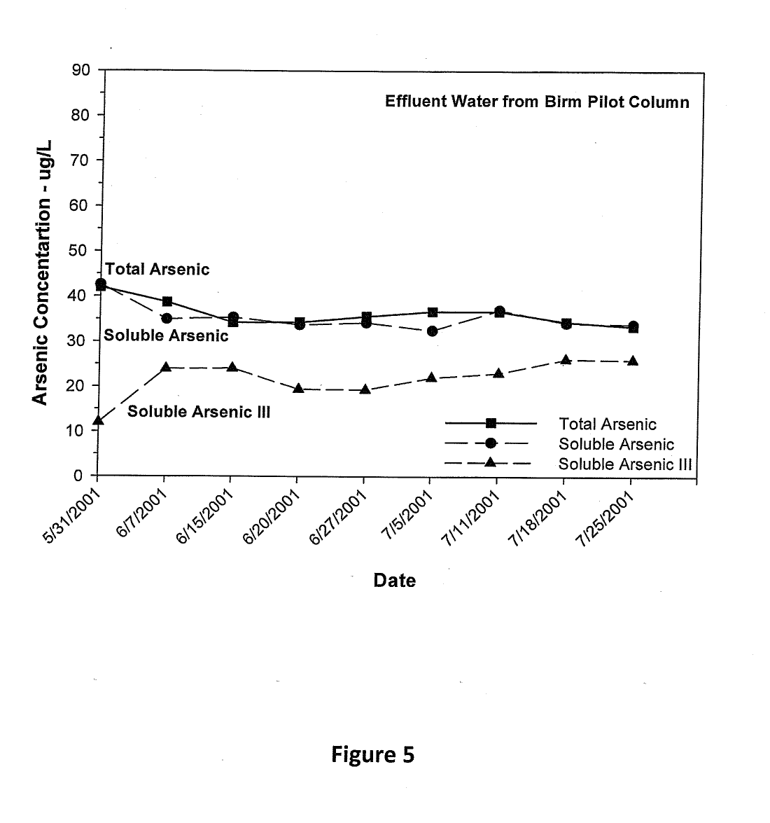

After replacing the media in all three columns, new tests were conducted using an EBCT of 5 minutes and all columns were backwashed every two days. Although the oxidation of arsenic improved, the results were still considered unsatisfactory. The best results occurred with Filox®, which is a manganese dioxide-based media (see FIG. 4), and the poorest results with Birm®, which is a manganese dioxide-coated media manufactured by Clack Corporation (see FIG. 5).

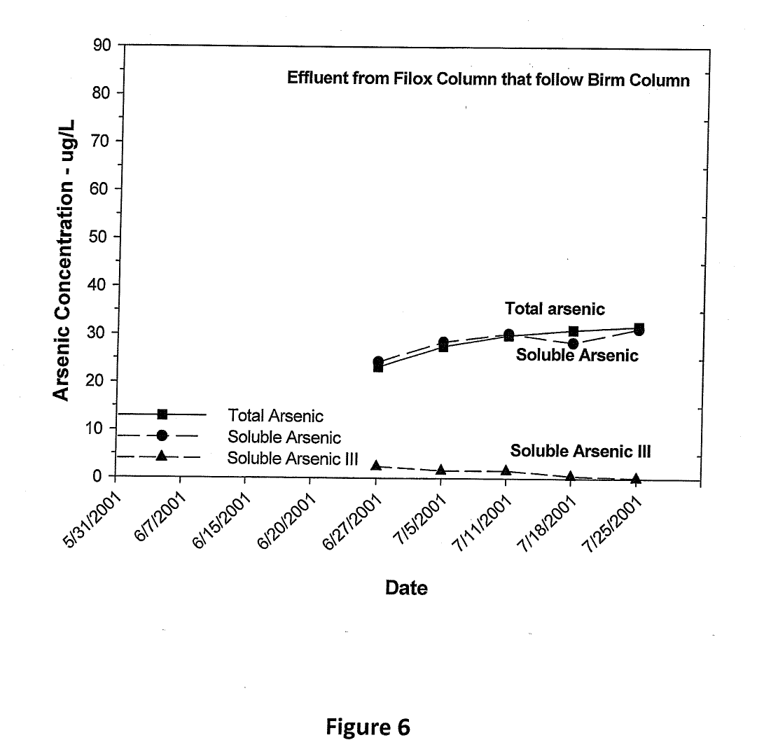

After three weeks of testing, the test system was modified to include a fourth test column that was loaded with fresh Filox® media, and which received the effluent from the Birm® column (FIG. 2b). The new combination system, the Birm® column followed by the Filox® column, produced the best As(III) oxidation results. With the Birm® column removing all of the iron and the manganese in raw water, the Filox® column achieved 87 to 98% As(III) oxidation during a five week test (see FIG. 6). Because of the effectiveness of Birm® to remove iron and manganese, backwashing of the Filox was not required.

The results of the pilot oxidizing media study also showed that all three oxidizing media could remove a fraction of arsenic from raw water. The amount of arsenic removed from an average raw water level of 65 μg/L was 33.7 μg/L (48.2%) for Pyrolox®, 36.1 μg/L(44.5%) for Birm®, and 27.8 μg/L (57%) for Filox®. The removal by Filox® was especially significant at the beginning of the run, with arsenic concentrations reduced to as low as 8.1 μg/L two days into the run. Removal rates leveled off to those of Pyrolox® and Birm® approximately three weeks into the run. When the Birm®-treated water was directed to a fresh Filox® column, the Filox® further reduced arsenic concentrations by approximately 18%.

Another advantage to the two-step Birm®/Filox® system was reduced backwashing flow requirements. Birm®, because of its low density, can be easily backwashed (see Table 1). Filox®, on the other hand, being a much heavier media, requires a higher pressure pump to achieve the same bed expansion as Birm® (see Table 1). With the two-step Birm®/Filox® system, only Birm® needs to be backwashed. Because Birm® removes iron and manganese, Filox™, does not require backwashing.

TABLE 1
Physical and Chemical Properties of Birm ® and Filox ®
Media

| Media | Filox ® | Birm ® |
|---|---|---|
| Color | Black | Black |
| Active Ingredient (wt %) | 75-85% MnO₂ | <0.01% MnO₂ |
| Mesh Size | 20 × 40 | 10 × 40 |
| Effective Size (mm) | Not Available | 0.48 |
| Bulk Density (g/L) | 1,826 | 681 |
| Bulk Density (lb/ft³) | 114 | 35-40 |
| Specific Gravity | 3.8-4.0 | 2.0 |
| Uniformity Coefficient | 1.45 | 2.7 |
| pH Range | 5.0-9.0 | 6.8-9.0 |

A major advantage of using a solid oxidizing media over a chemical oxidant is simplicity (no chemical addition). Another advantage of solid oxidizing media, mainly over the use of chlorine, is that it does not have the potential problem of disinfection by-products (DBPs) and it eliminates the requirement (and the cost) for DBP monitoring. For these reasons and others, Filox® may be used as a pre-oxidation step with small arsenic removal systems (using mainly ion exchange and adsorptive media processes) and has been found to be very effective in oxidizing As(III) to As(V).

As discussed above, studies on Filox® have found that it can be fouled (coated) by iron and even manganese and once it is fouled, it loses its ability to oxidize As(III) and must be replaced with virgin (fresh) media. Because of its high cost, therefore, it is not practical to use Filox® on groundwaters having moderate to high levels of iron that can quickly foul the media. For this reason, the use of Filox® has been limited to waters containing very small amounts of iron (<0.3 mg/L) and or manganese (<0.05 mg/L).

For groundwaters or other source waters containing iron and/or manganese, Filox® requires a pre-treatment step to the removal iron. With pre-treatment, Filox® is very effective for As(III) oxidation. However, the two-step process can be costly because of the need for two columns; the first column with Birm® to remove iron and manganese and the second column with Filox® to oxidize As(III). Water softeners have also been used to protect Filox®, but they require salt regeneration and can be more costly than using Birm®.

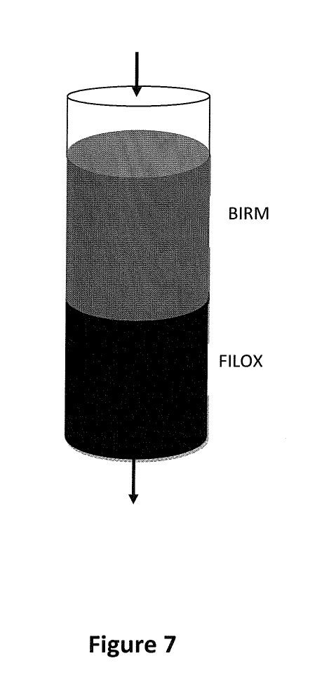

According to one embodiment of the present invention, an As(III) oxidation system may comprise a single column of Birm® on top of Filox® (see FIG. 7). It should be clearly understood that substantial benefit may also be derived from a single column of Birm® on top of Pyrolox® (or any other suitable pyrolusite) because Pyrolox® is a pyrolusite that is also effective in the oxidation of As(III). Because of the relative high cost of Filox® and because dissolved iron can quickly reduce Filox®'s As(III) oxidation capacity, its use is limited to only groundwaters containing very low levels of dissolved iron. Birm® is ineffective for As(III) oxidation, but very effective for iron removal. Moreover, Birm® is much lighter than Filox® with a density of less than one half of Filox's. Therefore, when the two media are used in a single column (mixed bed), Birm® will stay in the upper half of the bed and Filox® will remain in the lower half, even after backwashing. By placing Birm® on top of Filox®, the Birm® removes dissolved iron and manganese before they reach Filox®, thereby protecting Filox® from being coated with ferric hydroxide (iron) or manganese dioxide, which has a detrimental effect on Filox®'s capacity to oxidize As(III). It should also be clearly understood that while Birm® was used to remove dissolved iron and manganese, substantial benefit may be derived from any other suitable oxidizing media that may effectively remove dissolved iron and manganese from the groundwater or source water.

### Example 2

### Full-Scale As(III) System Evaluation Performance Study

A study was conducted wherein a 30-gpm Adsorbsia® GTO® adsorptive media arsenic removal system was to be used at the selected site. Adsorbsia® GTO® is a granular titanium oxide media manufactured by the Dow Chemical Company for arsenic removal.

TABLE 2
Physical and Chemical Properties of Adsorbsia ™ GTO ™
Media

| Parameter | Value |
|---|---|
| Product Type | Titanium oxide based |
| | granulation |
| Particle Size Range (mesh) | 10-60 |
| Moisture Content (%) | <15 |
| Bulk Density (g/L) | 705 |
| Bulk Density (lb/ft³) | 44 |
| Specific Surface Area (m²/g) | 200-300 |
| Pore Volume (cm³/g) | 0.20-0.25 |
| Equilibrium Capacity^{(a)} (@ 50 | |
| ppb, pH 7) | |
| Arsenic (V) (mg/g) | 12-15 |
| Arsenic (III) (mg/g) | 3-4 |

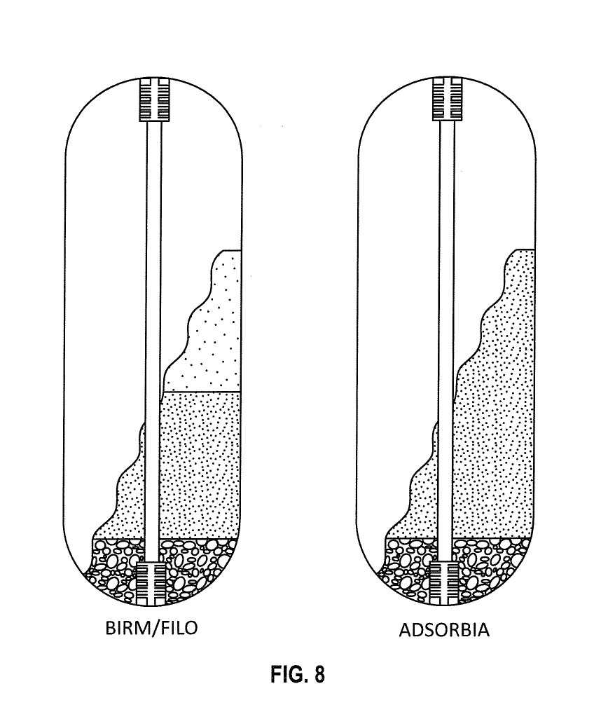

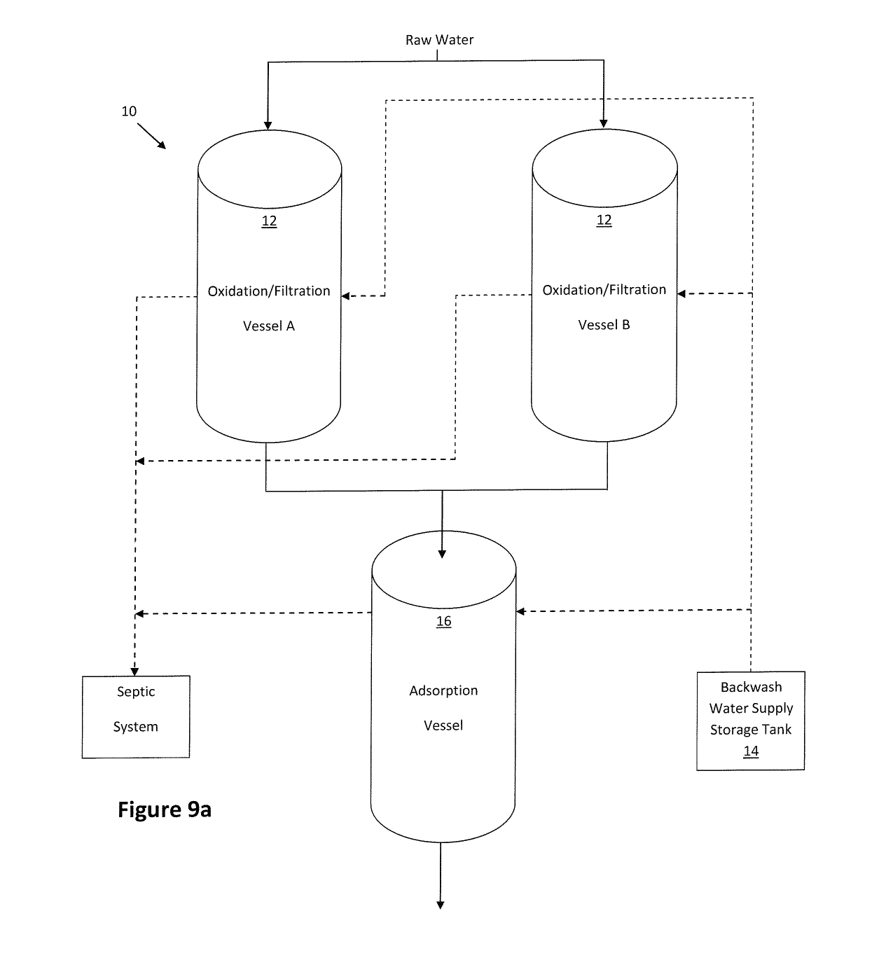

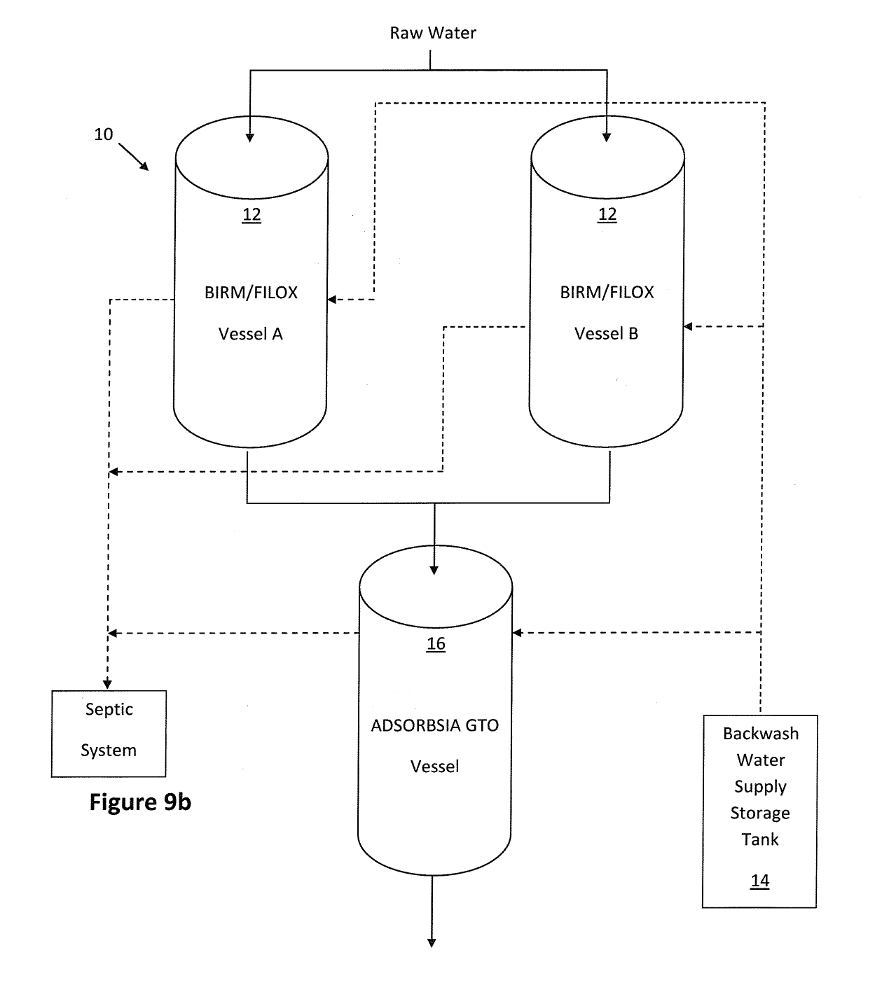

The source water at the selected site contained 13 to 15 μg/L of total arsenic with approximately 50% existing as As(III). The water also had an iron concentration of around 0.3 mg/L and a manganese concentration of 0.116 mg/L. Referring to FIG. 9a, to maximize the life of the adsorptive media 16, the water was pre-treated by a pre-oxidation system 12 for iron and manganese removal and pre-treated to oxidize soluble As(III) to soluble As(V). During this study, it was preferred not to use a chemical oxidant, such as chlorine, to oxidize As(III). Therefore, a Birm®/Filox® system was used for As(III) oxidation. As shown in the arsenic treatment system 10 of FIG. 9b, a Birm®/Filox® As(III) oxidation system 12 was used as a pretreatment to the Adsorbsia® GTO® adsorptive media system 16. The dual media (Birm®/Filox®) pretreatment system used in this study comprised two parallel 24-in×72-in vessels 12, each containing 5 ft³ of Birm® and 5 ft³ of Filox® (see FIGS. 8, 9a and 9b). A backwash system 14 may also be used. It should be clearly understood, however, that substantial benefit may also be derived from the use of a single Birm®/Filox® vessel or from the use of more than two Birm®/Filox® vessels in a Birm®/Filox® system pretreatment oxidation system, provided that the Birm®/Filox®vessels may be sufficiently backwashed. And while this embodiment used a 1:1 ratio of Birm® to Filox®, it should be clearly understood that further substantial benefit may be derived from the use of alternate ratios as long as a sufficient amount of Birm® is used to remove dissolved iron and manganese and to prevent fouling of Filox®. It should be also be clearly understood that while FIG. 8 shows a Birm®/Filox® filter and an Adsorbsia® GTO® filter having specific dimensions and amounts of Birm®/Filox® media and Adsorbsia® GTO®media, it should be clearly understood that substantial benefit may be derived from filters of alternative dimensions and from different amounts of the respective media as long as a sufficient amount of Birm® is used to remove dissolved iron and manganese and to prevent fouling of Filox® and as long as the Birm®/Filox® vessels may be sufficiently backwashed.

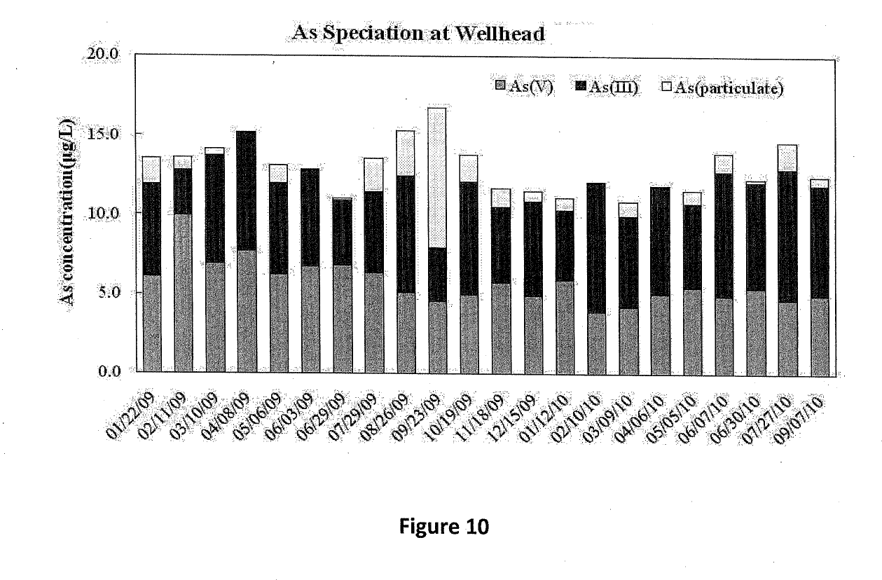

Operation of the complete As(III) treatment system lasted for 676 days, during which time the system treated approximately 5,198,000 gallons of water. As shown in FIG. 10, total arsenic concentrations in the site's well water measured during the testing period ranged from 9.4 to 21.1 μg/L and averaged 13.2 μg/L. Of the soluble fraction, As(III) and As(V), each accounted for about half of the total concentration at 6.0 and 5.8 μg/L, respectively (on average).

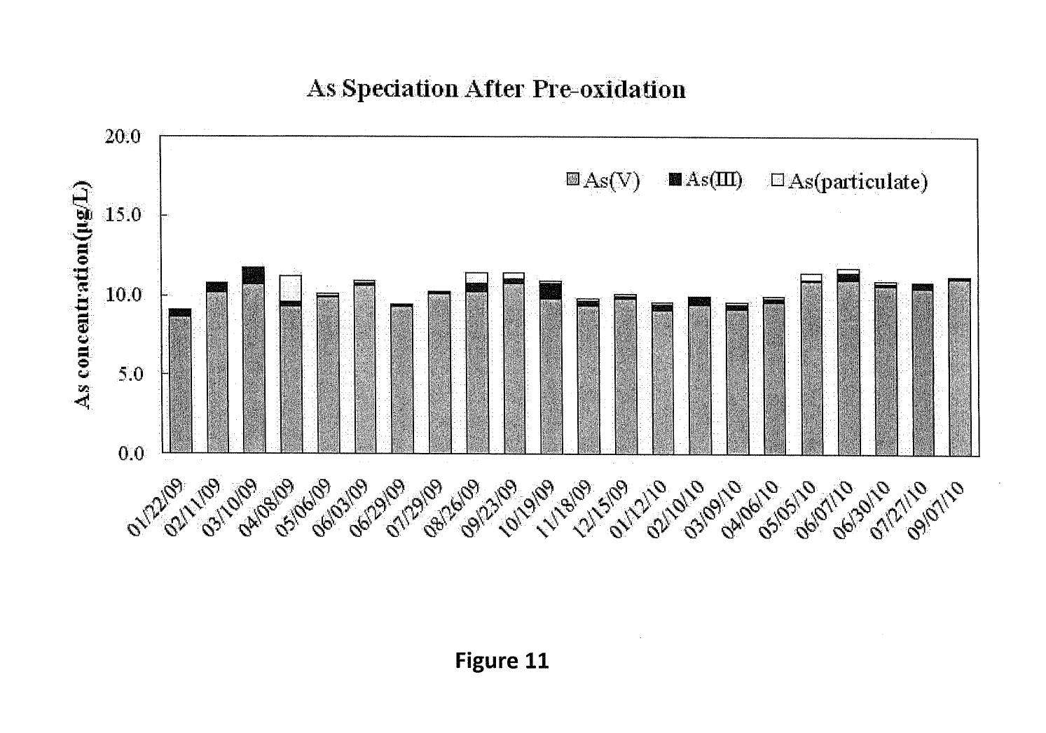

As seen in FIG. 11, the Birm®/Filox® pretreatment system decreased total arsenic concentrations by 21% to 10.4 μg/L (on average) in the influent to the Adsorbsia® GTO® adsorption vessel. The remaining arsenic existed primarily as soluble As(V) with concentrations ranging from 8.7 to 11.1 μg/L. Soluble As(III) and particulate arsenic concentrations were low, averaging 0.3 and 0.2 μg/L, respectively. Therefore, the Birm®/Filox® pretreatment system was found to be effective in oxidizing close to 100% of soluble As(III) to soluble As(V) throughout the study period. The Adsorbsia® GTO® then removed soluble As(V) to below the 10 μg/L arsenic MCL throughout the 22 month study period.

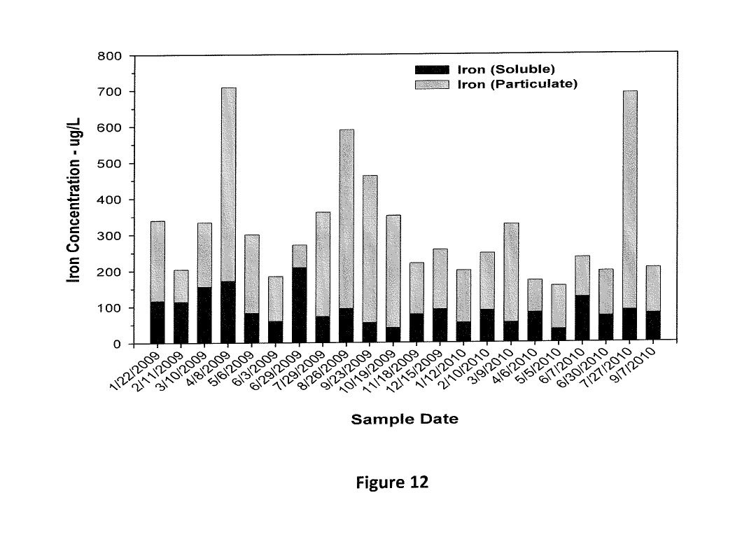

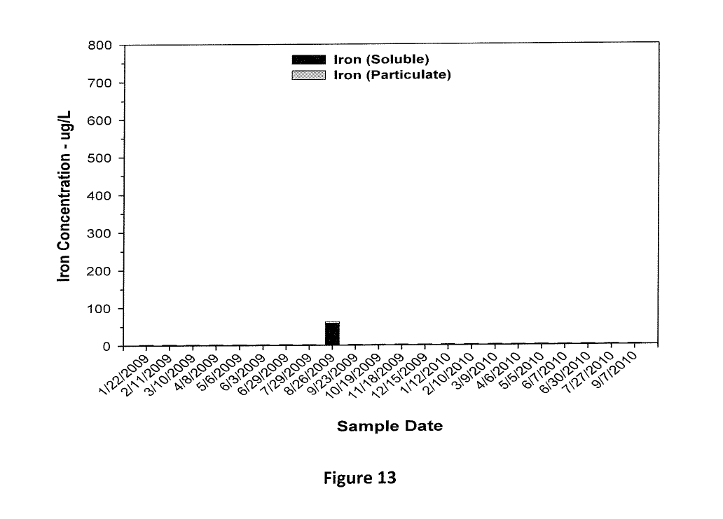

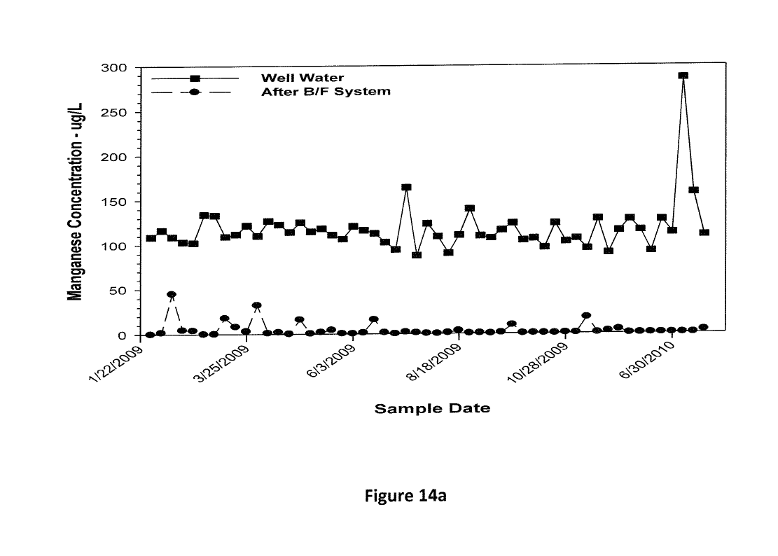

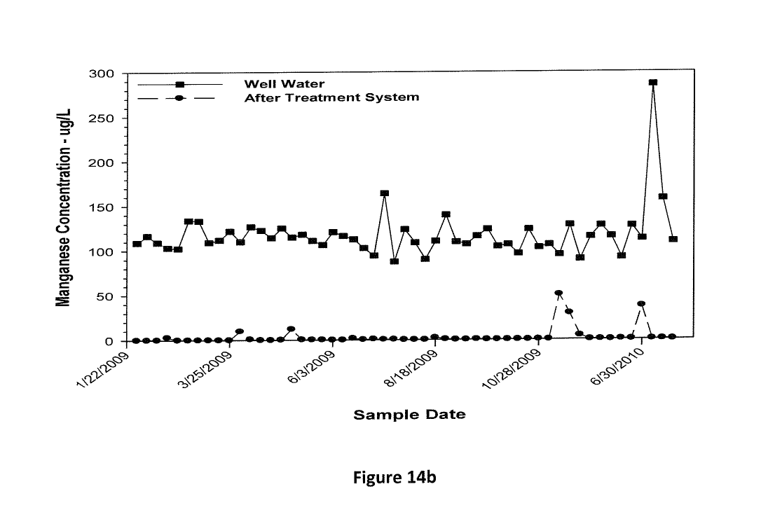

The Birm®/Filox® system was also effective in removing iron and manganese, reducing their concentrations to <25 and 4 μg/L (on average), respectively (see FIGS. 12, 13, 14a, and 14b). FIG. 12 shows iron speciation test results of the site's raw water and FIG. 13 shows the iron speciation of effluent from the Birm®/Filox® pre-oxidation system. It should be noted in FIG. 13 that Birm/Filox system removed all of the iron (both soluble and particulate) to below the iron detection limit which was 25 ug/L (except for in one measurement, as shown). FIG. 14a shows a significant decrease in manganese concentration in the site's water after having been treated by the Birm®/Filox® pre-oxidation system. And FIG. 14b shows an additional decrease in manganese concentration in the site's water after having been pretreated by a Birm®/Filox® pre-oxidation system and then subsequently treated by an Adsorbsia® GTO® adsorption system.

FIG. 15 shows the operation of an embodiment of an arsenic treatment system 10 of the present invention. As shown, backwashing may occur at the pre-oxidation vessels 12 (Birm®/Filox®) vessels and/or at the adsorption vessel 16 (Adsorbsia® GTO®) vessel. Daily backwashing at 15 gpm, the rate required to backwash the low density Birm® media, was effective in maintaining Birm®/Filox® performance; no sign of iron leakage or Adsorbsia® GTO® media fouling was observed during the performance evaluation study. Thus, this full-scale As(III) system evaluation performance study confirmed the results of the pilot studies that showed the ability of Birm®/Filox® to remove iron and manganese and to oxidize As(III) to As(V) with a single column system. It should be clearly understood that substantial benefit may still be derived from backwashing that occurs at other suitable locations or intervals.

Water samples may also be taken at several sample locations during treatment so that pH, temperature, DO/ORP (dissolved oxygen/oxidation reduction potential), and speciation test's may be conducted as well as tests for Fe levels, Mn levels, Ti levels, Ca levels, Mg levels, F levels, No₃ levels, SO₄ levels, SiO₂ levels, P levels, turbidity, alkalinity, and any other applicable tests that may be conducted to evaluate the system's performance. The testing may occur on a weekly or monthly basis or at any other suitable time interval.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A mixed-bed oxidizing media vessel for oxidizing arsenic(III) in source water having concentrations of at least one of iron and manganese, the mixed-bed media vessel comprising:
a housing;
a first oxidizing media for oxidizing at least one of dissolved iron and manganese present in the source water; and
a second oxidizing media for oxidizing arsenic(III) to arsenic(V) present in the source water;
wherein the second oxidizing media is positioned below the first oxidizing media within the housing.

2. The mixed-bed media of claim 1 wherein the first oxidizing media is a manganese dioxide-coated media.

3. The mixed-bed media of claim 2 wherein the manganese dioxide-coated media comprises less than 0.01 percent by weight of MnO₂.

4. The mixed-bed media of claim 2 wherein the manganese dioxide-coated media is a granular filter media sold under the trademark BIRM.

5. The mixed-bed media of claim 1 wherein the second oxidizing media is a manganese dioxide-based media.

6. The mixed-bed media of claim 5 wherein the manganese dioxide-based media is a pyrolusite media.

7. The mixed-bed media of claim 5 wherein the manganese dioxide-based media is a pyrolusite media sold under the trademark FILOX.

8. The mixed-bed media of claim 5 wherein the manganese dioxide-based media comprises between about 75 and about 85 percent by weight of MnO₂.

9. A system for oxidizing arsenic(III) in source water having concentrations of at least one of iron and manganese, the system comprising:
at least one mixed-bed media vessel for oxidizing at least one of dissolved iron and manganese and for oxidizing arsenic(III) to arsenic(V); and
a backwash system coupled to the at least one mixed-bed media vessel.

10. The system of claim 9 wherein the at least one mixed-bed media vessel comprises:
a housing;
a first oxidizing media for at least one of oxidizing ferrous iron to ferric iron and oxidizing reduced Mn²⁺ to Mn⁴⁺; and
a second oxidizing media for oxidizing arsenic(III) to arsenic(V);
wherein the second oxidizing media is positioned below the first oxidizing media within the housing.

11. The system of claim 10 wherein the first oxidizing media is a manganese dioxide-coated media comprising less than 0.01 percent by weight of MnO₂.

12. The system of claim 10 wherein the second oxidizing media is a manganese dioxide-based media comprising between about 75 and about 85 percent by weight of MnO₂.

13. The system of claim 10 wherein the housing comprises equal amounts of the first oxidizing media and the second oxidizing media.

14. The system of claim 9 wherein the at least one mixed bed media vessel comprises:
two parallel housings, each housing containing:
an amount of manganese dioxide-coated media comprising less than 0.01 percent by weight of MnO₂; and
an amount of manganese dioxide-based media comprising between about 75 and about 85 percent by weight of MnO₂;
wherein the manganese dioxide-based media is positioned below the manganese dioxide-coated media within the housing.

15. The system of claim 14 wherein the manganese dioxide-coated media is a granular filter media sold under the trademark BIRM and wherein the manganese dioxide-based media is a pyrolusite media sold under the trademark FILOX.

16. The system of claim 15 wherein each housing contains equal amounts of granular filter media sold under the trademark BIRM and pyrolusite media sold under the trademark FILOX.

17. A method for treating source water having concentrations of arsenic and at least one of iron and manganese, the method comprising the steps of:
providing a pre-oxidation system, wherein the pre-oxidation system comprises:
at least one mixed-bed media vessel comprising:
a housing;
a manganese dioxide-coated media; and
a manganese dioxide-based media;
wherein the manganese dioxide-based media is positioned below the manganese dioxide-coated media within the housing;
providing an adsorption vessel containing arsenic adsorption media coupled to the at least one mixed-bed media vessel;
providing a backwash system coupled to the at least one mixed-bed media vessel and to the adsorption vessel;
running the source water through the at least one mixed-bed media vessel;
oxidizing ferrous iron present in the source water to ferric iron with the manganese dioxide-coated media;
oxidizing reduced Mn²⁺ present in the source water to Mn⁴⁺ with the manganese dioxide-coated media;
oxidizing arsenic(III) present in the source water to arsenic(V) with the manganese dioxide-based media;
adsorbing arsenic(V) present in effluent from the at least one mixed-bed media vessel with the arsenic adsorption media in the adsorption vessel; and
backwashing at least one of the mixed-bed media vessel and the adsorption vessel.

18. The method of claim 17 further comprising the step of testing water samples obtained from at least one sampling location, wherein the sampling location is taken from one of influent from the water source, effluent from the at least one mixed-bed media vessel, and effluent from the adsorption vessel.

19. The method of claim 17 wherein the pre-oxidation system comprises:
two parallel housings, each housing containing:
an amount of manganese dioxide-coated media comprising less than 0.01 percent by weight of MnO₂; and
an amount of manganese dioxide-based media comprising between about 75 and about 85 percent by weight of MnO₂;
wherein the manganese dioxide-based media is positioned below the manganese dioxide-coated media within the housing; and
wherein the amount of manganese dioxide-coated media is equal to the amount of manganese dioxide-coated media.

20. The system of claim 19 wherein the manganese dioxide-coated media is a granular filter media sold under the trademark BIRM and wherein the manganese dioxide-based media is a pyrolusite media sold under the trademark FILOX.
